(19) United States
(12) Patent Application Publication
(10) Pub. No.: US 2025/0172209 A1
(43) Pub. Date: May 29, 2025

(54) Electromechanical Actuator with Sliding Piston for Improved Hydrodynamic Bearing

(71) Applicant: Robert Bosch GmbH, Stuttgart (DE)

(72) Inventors: Reiner Knoell, Burgsinn (DE); Marco Knoell, Burgsinn (DE); Michael Goldbach, Lohr A. Main (DE)

(21) Appl. No.: 18/957,032

(22) Filed: Nov. 22, 2024

(30) Foreign Application Priority Data
Nov. 27, 2023 (DE) 10 2023 211 787.8

(51) Int. Cl. F16H 57/04; F16H 25/20; F16H 25/24

(52) U.S. Cl. CPC F16H 57/0497; F16H 25/24; F16H 57/0412; F16H 57/0427; F16H 2025/2031

(57) ABSTRACT

An electromechanical linear actuator includes, among other things, a sliding piston with helical grooves for a floating bearing of a spindle in an electromechanical actuator. With relative movement of the spindle with respect to the sliding piston, a lubrication fluid passing through the grooves between the sliding piston and the spindle may assist in hydrodynamic lubrication between these two parts.

This application claims priority under 35 U.S.C. § 119 to application no. DE 10 2023 211 787.8, filed on Nov. 27, 2023 in Germany, the disclosure of which is incorporated herein by reference in its entirety.

The present disclosure relates to an electromechanical actuator with a sliding piston having the features set forth below.

### BACKGROUND

Electromechanical actuators are known from the prior art. For example, DE 10 2020 212 703 A1 discloses an electromechanical actuator designated as an “electric cylinder” therein, in which an end of a threaded spindle is connected to a piston, which divides an interior space of the actuator into a first and a second region, which are divided in a watertight manner. The first region is exclusively bounded by the piston and a cantilever projecting in the direction of an axis of rotation of the threaded spindle from a housing that receives the threaded spindle and the cantilever. The piston is rotatably supported on the threaded spindle via a sliding bearing and should preferably not rotate relative to the cantilever.

DE 10 2014 213 505 B4 also discloses an electric cylinder, in which the spindle bearing comprises a support device with a transverse rolling bearing (instead of the sliding bearing mentioned above). More specifically, in accordance with this disclosure, a pivot bearing can be moved radially to allow rotational movement.

However, friction between the sliding piston and the spindle may still be optimized in order to waste less energy, to have to dissipate less frictional heat produced, and, in particular, in order to minimize wear. For this purpose, rotation of the piston in the cantilever must be especially prevented.

In detail, in a linear actuator, a threaded spindle is rotatably supported on the housing by way of a pivot bearing with respect to the longitudinal axis. The cantilever is extendable and retractable by way of a nut screwed onto the threaded spindle. The threaded spindle is rotated via an electric motor. This results in (friction) heat, especially at the screw engagement of the threaded spindle and the nut. Therefore, the interior is filled with a fluid or mixture of lubricating oil and gas. The lubrication has a hermetic seal against the external atmosphere to eliminate leakage and contamination. Because the cantilever extends out of and retracts into the housing so that the internal volume changes, a complete filling with an incompressible fluid (or theoretically also with lubricating solids such as powder) is unfavorable, if not impossible. Conversely, no satisfactory lubrication and cooling can be achieved with pure gas. Thus, the fluid preferably consists of a portion of (incompressible) lubricating oil and a portion of (compressible) gas. If the nut moves, it displaces the fluid flowing through the cooling channels and past the threaded nut, for example, around rolling bodies bearing the threaded nut, as well as through channels in the spindle.

However, in particular when the cantilever is rapidly retracted and extended, the fluid cannot pass easily through the existing cooling channels and the threaded nut, so that a strong differential pressure is produced inside the linear actuator. This differential pressure results in a higher idle torque of the axle, which increases depending on the axle speed and thus the flow speed. This leads to a lower efficiency of the axle.

### SUMMARY

It is the object of the disclosure to eliminate or at least mitigate the disadvantages discussed above.

Thus, the present disclosure creates a linear actuator with a housing and a cantilever, which projects out of the housing in the direction of a longitudinal axis, wherein it is movable in the direction of the longitudinal axis, wherein a threaded spindle is rotatably supported on the housing at its first end by way of a spindle pivot bearing with respect to the longitudinal axis, wherein a second end of the threaded spindle opposite the first end in the direction of the longitudinal axis projects into the cantilever, no matter what position the cantilever is in, wherein the second end of the threaded spindle is provided with a sliding piston, which is abutting an inner peripheral surface of the cantilever in a manner that is substantially impermeable to fluids, such that it divides a first and a second cavity from one another within the linear actuator, wherein the second cavity is arranged on the side of the sliding piston facing away from the spindle pivot bearing, wherein the cantilever is rigidly connected to a threaded nut, which (e.g., via a plurality of rolling bodies) is screwed onto the threaded spindle, wherein the first cavity is at least partially filled with a liquid, wherein the threaded nut is open at both of its ends opposite one another in the direction of the longitudinal axis in such a manner that the liquid can pass through the threaded nut upon movement of the cantilever, wherein a first longitudinal channel is located inside the threaded spindle, which extends along the longitudinal axis, wherein the first longitudinal channel is fluidly connected to the first cavity at its ends opposite to one another with respect to the longitudinal axis in such a manner that the fluid may flow through the first longitudinal channel upon movement of the cantilever bypassing the threaded nut, no matter what position the cantilever is in, and wherein a sliding bearing flows between the sliding piston and the threaded spindle in this flow. That is to say, that the sliding piston in particular is aligned with the threaded spindle and is geometrically designed such that one part of the flow flows between these two components and another part of the flow flows through the sliding piston itself.

In particular, the present disclosure creates a sliding piston, in which rotation with respect to the cantilever is prevented by the seal friction on the piston being higher than the torque that occurs as resistance in the hydrodynamic bearing in each operating state. A breakage of the lubricating film is prevented so that no “fretting” or increased wear occurs that would destroy the bearing. This is especially important with changing temperatures in external use and the associated changing viscosity of the lubricant.

An elastomeric sliding bearing is not applicable due to the temperature requirements in external use. Since the coefficients of thermal expansion of elastomer and steel are too different, too much play would be created at a higher temperature. Although a solution similar to DE 10 2014 213 505 B4 could be used, the floating bearing would have to be very delicate due to the additional flow channels. This idea is therefore considered uneconomical for cost and durability reasons.

According to the present disclosure, this is achieved by a sealing piston with optimized geometry and an optimized selection of materials. The second region of the electromechanical actuator is partially filled with lubricating oil, similar to that of DE 10 2020 212 703 A1. A first fluid flow path is provided comprising the bearing gap of the piston sliding bearing, wherein the first fluid flow path runs in such a way that movement of the cantilever causes a flow of lubricating oil in the first fluid flow path, particularly through the piston sliding bearing. In connection with the present disclosure, it is, however, most of all important that the lubricating oil, which is displaced on the one side of the threaded nut, can reach the other side of the threaded nut via the spindle channel.

The piston runs on the threaded spindle on a circular cylindrical surface with respect to its longitudinal axis. More specifically, the spindle rotates in the piston while the piston does not rotate, to the extent possible.

The stem is preferably arranged to fully penetrate the piston. On the side of the threaded spindle facing away from the (actual) thread for displacement of the cantilever via the threaded nut, a nut may be screwed onto an external thread of the threaded spindle that holds the piston axially on the threaded spindle. The threaded spindle (and also a spindle channel present in the threaded spindle) thus goes through the nut. Lubricant fluid flowing out of the spindle channel may thereby pass through the piston to the side of the piston facing away from the threaded spindle.

By way of helical grooves in the piston, more precisely in the area of sliding contact, made on the side facing the spindle, the majority of the fluid flow can flow in the first fluid flow path when the spindle and fixed sliding piston are rotated. Starting from these grooves, the lubricating oil can easily spread into the actual bearing gap. The grooves preferably run continuously from the piston end face, which abuts the threaded spindle, over the inner circumferential surface of the piston, so that there is not a constriction for the oil flow anywhere.

Thus, hydrodynamic lubrication of the sliding bearing is improved.

Preferably, the grooves are helically shaped such that the flow of oil is supported in the first fluid flow path.

A second fluid flow path may be formed by bores in the piston parallel to the axis. This second fluid flow path is parallel to the first fluid flow path. The amount of flow resistance (in other words the diameter) of the axially parallel bores can be used to control what proportion of the entire oil flow flows through the sliding bearing. Preferably, the ratio between the cross-sectional area of the grooves and the through bores is between 50 and 200%, in other words, the cross-sectional area of the through bores is between half and twice the cross-sectional area of the grooves.

A seal consisting of guide rings and dynamically acting sealing rings is provided on the exterior of the piston. These components are standard commercially available products, which reduces the overall cost. The friction of the sealing rings must be so high that the relative movement takes place on the spindle surface and not on the guides and seals of the piston. The piston should, therefore, not rotate.

Advantageously, in contrast to the closest prior art, not plastic but a wrought aluminum alloy with a high silicon content is also used as a piston material. As a result, the coefficient of expansion of the piston approaches the coefficient of other parts of the electromechanical actuator, particularly the coefficient of the sleeve and the spindle, which are also made of metallic materials and work in cooperation with the piston. This allows for more stable lubrication in a wider temperature range. The high silicon content improves the emergency running properties.

The construction with the features discussed above achieves, in comparison to DE 10 2020 212 703 A1, that the fluid in the hermetically sealed interior of the electromechanical actuator can flow from the interior of the sleeve or cantilever to the deep bore in the spindle and vice versa.

Although this illustration relates to “through bores”, “deep bores”, etc., it should be apparent to those skilled in the art that the corresponding coupling channels between fluid ingress and egress on surfaces as well as blind holes can be produced not only by drilling but also by any other manufacturing methods (including etching, additive manufacturing, erosion, etc.). Nonetheless, for simplicity, “bores” is written in this illustration.

### BRIEF DESCRIPTION OF THE DRAWINGS

FIG. 1 shows a linear actuator according to the disclosure for clarifying the fluid circulation.

FIG. 2 is an isometric representation of a sliding piston in accordance with a first exemplary embodiment of the present disclosure;

FIG. 3 is an isometric representation of the sliding piston of FIG. 2 seen from the other side; and

FIG. 4 is a representation of the sliding piston and its surroundings in an electromechanical actuator in an installed state as an enlarged part of FIG. 1.

### DETAILED DESCRIPTION

Two exemplary embodiments of the present disclosure will be described in the following on the basis of the accompanying figures.

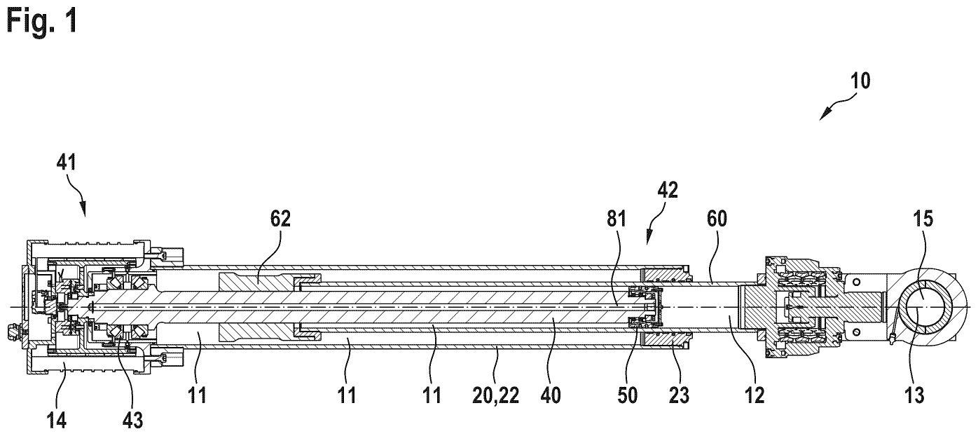

FIG. 1 shows a linear actuator 10 having a housing 20 and a cantilever 60 projecting out of the housing 20 along a longitudinal axis 13 (vertical in the figure). The cantilever 60 is movable in the direction of the longitudinal axis 13. A threaded spindle 40 is rotatably supported on or in the housing 20 at its first end 41 by way of a spindle pivot bearing 43 about the longitudinal axis 13 and is driven by a motor connected to the first end 41. A second end 42 of the threaded spindle 40 opposite the first end 41 in the direction of the longitudinal axis 13 always projects into the cantilever 60. The second end 42 of the threaded spindle 40 is provided with a sliding piston/piston 50, which abuts an inner peripheral surface of the cantilever 60 in a manner that is substantially impermeable to fluids, in such a way that it divides a first and a second cavity 11; 12 in the linear actuator 10 from one another. The second cavity 12 is arranged on the side of the sliding piston 50 facing away from the spindle pivot bearing 43. The cantilever 60 is rigidly connected to a threaded nut 62, which (directly or preferably via a plurality of rolling bodies not shown here, e.g., planets) is screwed onto the threaded spindle 40. The first cavity 11 is at least partially filled with a liquid, more specifically in this embodiment, it contains a fluid that is a mixture of liquid, e.g., lubricating oil, and gas, for example, nitrogen. The threaded nut 62 is open at its two ends lying opposite one another in the direction of the longitudinal axis 13 such that the liquid can flow through the threaded nut 62 upon a movement of the cantilever 60. A first longitudinal channel 81 is located inside the threaded spindle 40 and extends along the longitudinal axis 13. The first longitudinal channel 81 is fluidly connected at its ends opposite to the longitudinal axis 13 to the first cavity 11 (at the first end 41, for example, through transverse bores, which open into the longitudinal channel, which is illustrated in the figure by some points connected to a “thick dash”), such that the fluid may flow through the first longitudinal channel 81 upon movement of the cantilever 60 regardless of its position, even by bypassing the threaded nut 62, wherein said flow passes through and thus lubricates a sliding bearing between the sliding piston and the threaded spindle.

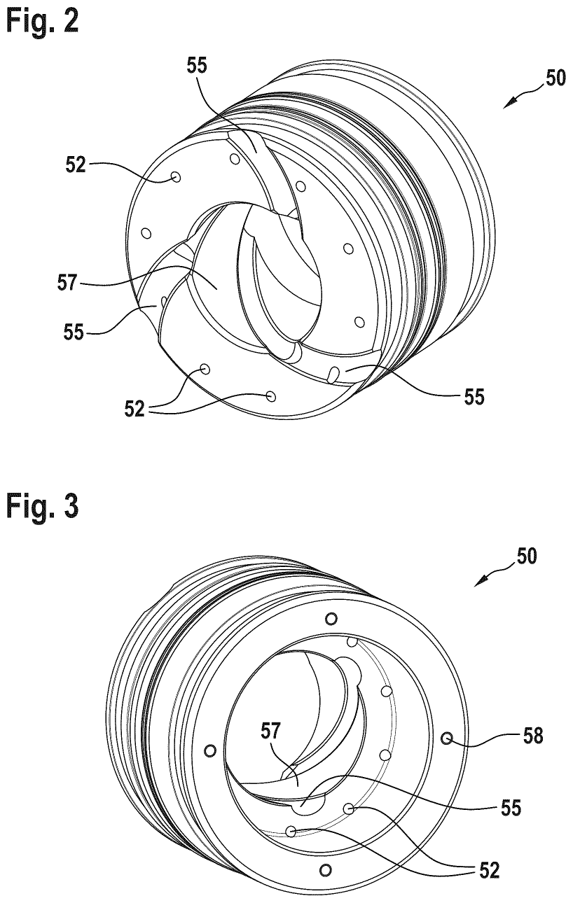

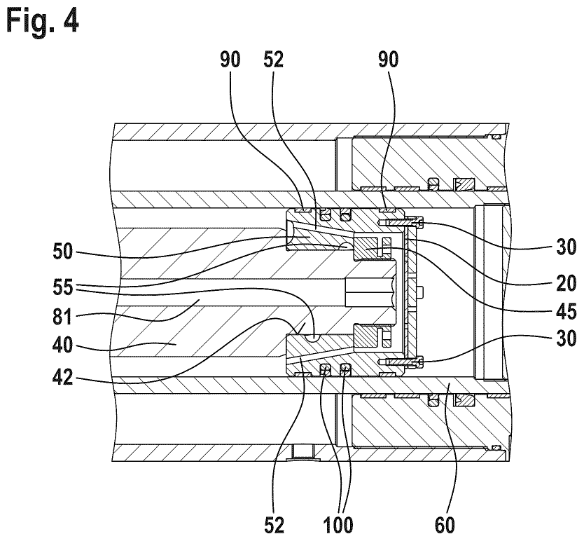

FIG. 2 shows the sliding piston 50 installed in FIGS. 1 and 4 from the side abutting the threaded spindle of the electromechanical actuator, i.e., seen from the left side seen in FIGS. 1 and 4. Several inlets of bore holes 52, as well as, in this embodiment, three circumferentially spaced helical grooves 55, can be seen. These grooves 55 form a first fluid flow path for the lubricating oil. The grooves 55 extend continuously from the piston end face, which abuts a threaded spindle 40, over the inner peripheral surface of the sliding piston 50, so that there is nowhere that the oil flow is restricted. The grooves 55 are helically shaped such that the flow of oil during rotation of the threaded spindle 40 and, thereby, simultaneous insertion or extension of a cantilever 60 is supported. The bore holes 52 form a second fluid flow path.

FIG. 3 shows the same sliding piston 50 in isometric view from the other side (in FIGS. 1 and 4 from the “right”). In addition to the bore holes 52 and the grooves 55, four threaded blind holes 58 can be seen distributed around the perimeter. From the comparison of the exits of the bore holes 52 in FIGS. 2 and 3, but better still in the section of FIG. 4, it can be seen that the bore holes 52 run obliquely through the sliding piston. The aforementioned threaded blind holes 58 serve to secure an axial seal 20 (shown in FIG. 4) to the sliding piston 50 by way of screws 30. This axial seal 20 may be formed as a check valve (explained in more detail in a parallel application), for example membrane-based, or comprise such a check valve, and in this case convey fluid into cantilever 60 again via the spindle channel 81 in the threaded spindle 40 as well as via the bore holes 52 to the side of the threaded spindle. Fluid, particularly incompressible lubricating oil or grease that enters the cantilever through negative pressure encountered during extension could otherwise inhibit retraction if it could not leave the hermetically sealed cantilever.

From FIG. 3, it can also be seen that space for a threaded nut 45 (see FIG. 4) is created in the sliding piston. This threaded nut 45 is screwed onto an external thread of the spindle 40 after application of the sliding piston 50 to the threaded spindle 40 and axially holds the sliding piston 50 on a circular-cylindrical surface. The spindle channel 81 goes through external thread and, thus, also the threaded nut 45.

In contrast to pistons of the prior art in which POM plastic is used, it has been found advantageous in the present disclosure to produce the piston 50 from a wrought aluminum alloy with a high silicon content. This material has a similar thermal expansion to the metallic cantilever 60 and spindle 40, so that lubrication can remain stable in a wide temperature range.

As can be seen from FIG. 4, the piston is supported on the cantilever 60 via guiding bands 90 and works together with seals 100 to seal between the first cavity 11 and the second cavity 12 (not shown again in FIG. 4 for clarity) on the left and right of the sliding piston 50. The first cavity 11 is a region filled with lubricating fluid around the spindle 40, whereas the second cavity 12 to the right of the axial seal is a largely lubricating fluid-free region in the cantilever 60. The guiding bands 90 and seals 100 serve to support the piston in the cantilever 60 so that it is not able to rotate, to the extent possible. Relative rotation should only occur between the spindle 40 and the sliding piston 50. This is achieved by selecting the friction of the seals 100 on the cantilever 60 and sliding piston 50 so high that the relative movement takes place at the spindle surface 42 and not on the guiding bands and seals of the sliding piston 50. This is facilitated by a lower frictional force being generated at the outer diameter of the sliding piston 50 to compensate for the torque occurring between the spindle surface 42 and an associated running surface 57 of the sliding piston 50 because the running surface 57 of the sliding piston 50 is further inward than the seals 100.

The guiding bands 90 take over the radial loads occurring during operation as guiding elements that are common in corresponding cylinders. Typically, the guiding bands 90 are made of plastic or a soft metal to avoid contact between the metallic components of the linear actuator. The material of the guiding bands 90 provides lower friction and, due to its better elastic deformation, a greater contact area than the metallic components “sliding pistons 50” and “cantilever 60”. In addition, self-lubricating material, e.g., corresponding plastic, can be used. Such standard elements are inexpensive to purchase in any size.

The sliding piston 50 is thus kept non rotational relative to the cantilever 60 by the guiding belts 90 and (especially) the seals 100 and thus slides on a spindle surface 42. The lubrication grooves 55 in the sliding piston 50 allow a flow of lubrication fluid from the spindle channel 81 to the first region via both the bore holes 51 and the grooves 55 and vice versa. Thanks to the grooves 55, the lubricating fluid forms a lubricating film between the sliding piston 50 and the spindle surface 42.

In summary, the present disclosure creates a linear electromechanical actuator 10 having, among other things, a sliding piston 50 with helical grooves 55 for a floating bearing of a spindle 40. With relative movement between spindle 40 and sliding piston 50, a lubrication fluid passing through grooves 55 between sliding piston 50 and spindle 40 may assist with hydrodynamic lubrication between these two parts.

What is claimed is:

1. A linear actuator, comprising:
a housing;
a threaded spindle rotatably supported on the housing at a first end by way of a spindle pivot bearing with respect to a longitudinal axis; and
a cantilever which projects out of the housing in the direction of the longitudinal axis,
wherein the cantilever is movable in the direction of the longitudinal axis,
wherein a second end of the threaded spindle opposite the first end in the direction of the longitudinal axis projects into the cantilever, irrespective of the position the cantilever,
wherein the second end of the threaded spindle is provided with a sliding piston which is abutting an inner peripheral surface of the cantilever in a manner that is substantially impermeable to fluids such that it divides a first cavity and a second cavity from one another within the linear actuator,
wherein the second cavity is arranged on the side of the sliding piston facing away from the spindle pivot bearing,
wherein the cantilever is rigidly connected to a threaded nut, which is screwed onto the threaded spindle,
wherein the first cavity is at least partially filled with a liquid,
wherein the threaded nut is open at both of its ends opposite one another in the direction of the longitudinal axis in such a manner that the liquid passes through the threaded nut upon movement of the cantilever,
wherein a first longitudinal channel is located inside the threaded spindle, which extends along the longitudinal axis,
wherein the first longitudinal channel is fluidly connected to the first cavity at its ends opposite to one another with respect to the longitudinal axis in such a manner that the fluid flows through the first longitudinal channel upon movement of the cantilever bypassing the threaded nut, irrespective of the position the cantilever, and
wherein a sliding bearing flows between the sliding piston and the threaded spindle in this flow.

2. The linear actuator according to claim 1, wherein the sliding piston comprises bore holes configured to pass fluid therethrough in a direction parallel to the threaded spindle and to create a fluid connection between the first cavity and second cavity.

3. The linear actuator according to claim 2, wherein the bore holes run towards a center axis of the sliding piston.

4. The linear actuator according to claim 2, wherein a cross-sectional area of the bore holes is between 50% and 200% of a cross-sectional area of the grooves.

5. The linear actuator according to claim 4, wherein as the cantilever moves, more fluid also flows through the bore holes than through the sliding bearing and grooves.

6. The linear actuator according to claim 1, wherein the sliding piston is made of a wrought AlSi alloy.

7. The linear actuator according to claim 1, further comprising guiding bands and seals provided on the outer side of the sliding piston and configured to keep the sliding piston fixed to the cantilever by way of friction so that it does not rotate.

8. The linear actuator according to claim 1, further having an enlarged internal space opposite a running surface of the sliding piston and configured to receive a threaded nut.

9. The linear actuator according to claim 1, further having threaded holes for securing an axial seal by way of screws.

10. The linear actuator according to claim 9, further including an axial seal comprising a check valve and conveying fluid into the cantilever again via the spindle channel in the threaded spindle as well as via the bore holes to the side of the threaded spindle.
